(19) United States
(12) Patent Application Publication
(10) Pub. No.: US 2011/0203273 A1
(43) Pub. Date: Aug. 25, 2011

(54) Hydrostatic aspiration thermal concentrator

(76) Inventor: Daniel South, Palmer, AK (US)

(21) Appl. No.: 12/803,269

(22) Filed: Jun. 22, 2010

Related U.S. Application Data
(60) Provisional application No. 61/338,919, filed on Feb. 25, 2010.

(51) Int. Cl. F03G 7/04

(52) U.S. Cl. 60/641.7

(57) ABSTRACT

With the discovery of the Hydrothermal Aspiration Concentration Method claimed herein a valuable new method of a system of components to extract thermal energy from a body of liquid and convert it to continue the operation of the device and perform other useful work is invented. Additionally the Hydrothermal Aspiration Extraction Process claimed herein defines the transformation of thermal energy present in bodies of liquids into kinetic energy utilizing the Hydrothermal Aspiration Concentration Method to achieve the transformation. The above method and process are applied to achieve the design of the Hydrostatic Aspiration Thermal Concentrator device, also claimed herein. The invention includes a method, process and apparatus for extracting and converting the thermal energy present in bodies of liquids utilizing a portion of the converted energy to operate the device, and also to perform other useful work.

### CROSS-REFERENCE TO RELATED APPLICATIONS

This patent application claims priority from provisional patent application No. 61/338,919 having a filing date of Feb. 25, 2010.

### FIELD OF THE INVENTION

The invention pertains to the field of hydrostatic pressure gradient and hydrothermal energy operated devices which extract and convert thermal energy from water body and/or atmosphere to perform useful work and for other purposes.

### BACKGROUND OF THE INVENTION

Deep bodies of liquid exert great hydrostatic pressures which are proportionally larger at greater depths, commonly referred to as water column height.

Great bodies of water possess massive thermal energy. Typically their average temperature at all depths is well in excess of that which would result in their solidification as ice.

Known scientific principles detail the thermal energy present in a liquid of a certain temperature and the thermal energy, pressure and volume conditions necessary to vaporize the certain liquid quantity into it's gaseous phase.

These and other known scientific principles can be employed to process a quantity of liquid to and from liquid and gaseous phases or state as is performed in typical heat exchanger type of applications wherein the fluid is referred to as the working fluid.

In the invention apparatus, differential hydrostatic forces begin the operation of the device which then extracts thermal energy from surrounding liquid sufficient to continue operating the device to additionally include the performance of other useful work.

Prior art in this field relates to other types of hydrothermal and hydrokinetic energy extraction devices such as flowing water, wave, tide and hydrothermal gradient related systems, but to my knowledge no patents have been granted for a device which functions as the invention herein.

### BRIEF SUMMARY OF THE INVENTION

It is an object of the vertically installed submerged invention apparatus to continuously operate the device to extract and convert the thermal energy present in water bodies by utilization of a portion of the converted energy to continue the operation of the device.

Initial differential hydrostatic forces present between lower inlet and upper outlet depths of begin the operation of the device. Thermal energy extracted from surrounding liquid is then converted to kinetic energy utilized partly maintain the operation of the device and to also perform useful work.

When operating the device continually maintains water column height pressure difference between the inlet and outlet of the device, plus performing other useful work.

Differential hydrostatic forces initially present and subsequently maintained between lower inlet and upper outlet depths perform the work of forcing a quantity of the body of liquid upward through a system of liquid and vapor processing components and thermal energy is extracted from surrounding water body for conversion to other useful work purposes.

In the practice of the inventive concepts, devices of many embodiments of the invention may be produced, but each device must necessarily conform to the dictates of the inventive concepts herein.

The invention enables the construction of such a useful apparatus as the Hydrostatic Aspiration Thermal Concentrator device which has the capacity to perform massive useful work of various forms the continuing operation of which is possible as long as great bodies of water or other liquids exist from which thermal energy may be processed by the device.

### BRIEF DESCRIPTION OF THE SEVERAL VIEWS OF THE DRAWING

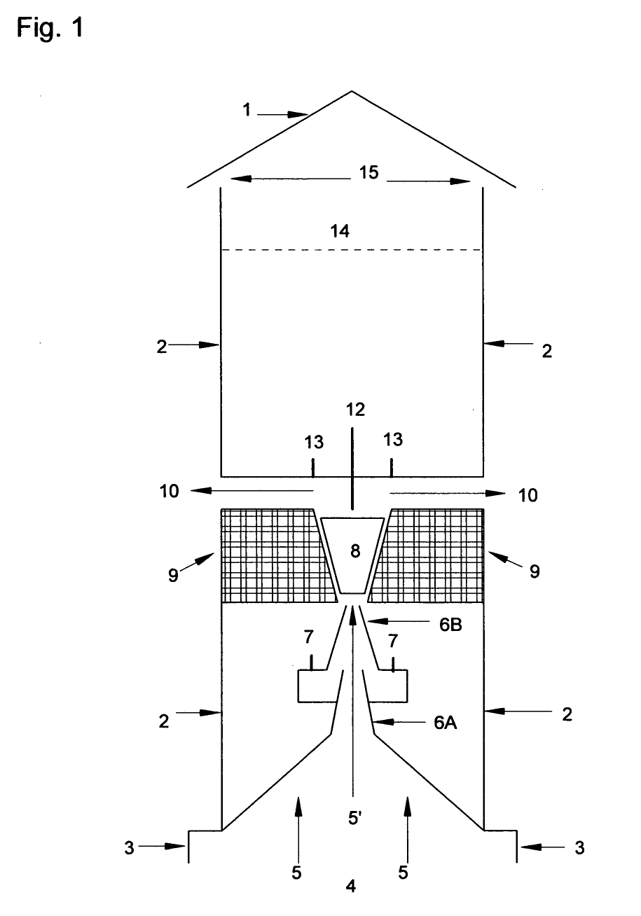

FIG. 1: Front page view:
Cross section view at center line plane of entire structure.

### DETAILED DESCRIPTION OF THE INVENTION

The following paragraphs reference the drawing sheet and illustrate the design and steps of operation of a basic example of a the preferred embodiment of the device. The following primary aspects of the apparatus are as follows:

Basic Structure:
vertical hull 2 mounted 3 in great body of water floor 3 as large upright cylinder shape
water input opening area 5 at structure bottom just above mounting to water body floor 3
roof like eave vented peaked cap 1 at top of structure above surface of water 14
multiple lateral steam turbine exhaust ports 10 with proximate air bleed valves 13
steam jet injector nozzle assembly 6A/B with suction air valves 7 supplied from vents 15
steam jet injector top nozzle (expansion chamber/screw turbine 8 area) surrounded and integrated to surrounding liquid radiator 9 to absorb heat of enthalpy wherein vapor is expanding from liquid to cold steam

Elementary Design Factors and Assumptions:
placed or constructed in large body of fresh water—additional considerations for salt water primarily for possible removal of excess salt solids
watertight hull structure 2 except for water input opening(s) 5, exhaust ports 10 and roof cap eave vents 15
initial hydrostatic fluid pressure 5′ at water input 5 sufficient to force liquid though injector nozzles and into wedge shaped screw turbine 8 and change state to cold steam
thermal energy gain sufficient to drive turbine 8 and exhaust liquid 10 and perform work
design of nozzles relative to liquid properties, water column height from inlet to outlets . . .

Theory of Operation:
input water valve system (not shown) is opened following initial construction AND/OR hull structure is evacuated of surrounding liquid following initial construction
hydrostatic fluid pressure 5′ begins to force liquid through nozzle assemblies 6A/B and into top nozzle/expansion chamber/turbine 8 area
turbine output shaft 12 performs designed load of work and additionally pumps exhaust water at turbine exhaust ports 10
continuous operation depends on thermal energy gain to drive turbine and exhaust
turbine flow metrics determine continuing effective water column pressure
original water column height design factor is maintained overall and at input to turbine by turbine operation on vapor and turbine exhaust

Other Information & Alternate Embodiments (Not Shown):
turbine output shaft work possibilities include electrical generator but also many others
structure could be adapted to mobile floating apparatus situated in great water body
turbine output could power buoyancy management systems and vessel power
additional various embodiments include submerged or purely atmospheric open or closed loop liquid system drawing heat from liquid body or only atmosphere by various means

In summary, the preferred embodiment of the invention detailed above is a hydrothermal energy extraction and conversion device utilizing converted energy to operate.

In alternate embodiments of the invention (not shown), other combinations of features of conventional may be incorporated into the various device designs enabled by application of the inventive concepts herein.

1. A method—also known as the Hydrothermal Aspiration Concentration Method—of the operation of a system of components to extract and convert thermal energy from a body of liquid to kinetic energy to operate the device and perform other useful work.

2. A process—also known as the Hydrothermal Aspiration Extraction Process—of extracting and transforming thermal energy present in bodies of liquids into kinetic energy utilizing the method claimed in claim 1 to achieve the transformation.

3. An apparatus of a Hydrothermal Aspiration Thermal Concentrator device assembly utilizing the process claimed in claim 2 to produce the motive force to operate the device and additionally preform other useful work.

4. An apparatus of a system of components utilizing the process claimed in claim 2 to produce the motive force to operate the device and perform other useful work.
